(19) United States
(12) Patent Application Publication
(10) Pub. No.: US 2026/0292270 A1
(43) Pub. Date: Sep. 24, 2026

(54) METHOD, APPARATUS FOR PLAYING CONTENT, AND DEVICE, MEDIUM AND PROGRAM PRODUCT

(71) Applicant: Beijing Zitiao Network Technology Co., Ltd., Beijing (CN)

(72) Inventors: Gelin WU, Beijing (CN); Xiaoyun YU, Beijing (CN); Chengjun ZHANG, Beijing (CN)

(21) Appl. No.: 19/577,164

(22) Filed: Mar. 24, 2026

(30) Foreign Application Priority Data
Mar. 24, 2025 (CN) 202510352395.X

(51) Int. Cl. H04N 21/2187; H04N 21/23

(52) U.S. Cl. CPC H04N 21/2187; H04N 21/23

(57) ABSTRACT

Embodiments of the present disclosure relate to a method, an apparatus, a device, a medium, and a program product for playing content. The method includes receiving, at a first client and through a media stream channel, a target media stream from a second client for live streaming, a media frame of the target media stream including metadata. The method further includes determining a message identifier in the metadata in response to the metadata indicating that the media frame is displayed synchronously with a corresponding message. The method further includes determining whether there is a target message with the message identifier in a message queue of a message channel for the live streaming. The method further includes displaying the media frame and the target message synchronously in response to there being the target message in the message queue.

### CROSS-REFERENCE TO RELATED APPLICATION(S)

This application claims priority to Chinese Application No. 202510352395.X filed Mar. 24, 2025, the disclosure of which is incorporated herein by reference in its entirety.

### TECHNICAL FIELD

Embodiments of the present disclosure generally relate to the field of live streaming, and in particular, to a method, an apparatus, a device, a medium, and a program product for playing content.

### BACKGROUND

At present, in a live streaming scenario, more and more live streaming content is discovered and used to show to a large number of audiences watching the live streaming, including content in aspects such as popularizing knowledge, entertaining the public, and competitive games. In a process of a streamer streaming live, the streamer usually interacts with other streamers or audiences, and the other streamers or the audiences may participate in the interaction together by inputting words or giving gifts in a live streaming room. As the popularity of the live streaming room increases, the number of people participating in the interaction in the live streaming room also increases. At this time, related interaction operations in the live streaming room will become more and more frequent, and the transmission pressure of data streams between the live streaming room and the audiences will also become greater and greater.

With the rise of the live streaming industry, more and more people begin to pay attention to this field and join the live streaming industry, and the number of streamers in the current live streaming industry has shown an explosive growth. With a sharp increase in the number of streamers, interactions between the streamers and the audiences have also been created at the right moment. Different from a traditional simple dialogue interaction between a streamer and an audience, a streamer may now perform related interactions with audiences through different interaction operations in different interaction scenarios, which greatly improves the fun of the audiences watching the live streaming, increases the frequency of interactions between the streamer and the audiences, brings more popularity to the live streaming room, and also brings more severe challenges in terms of experience of the live streaming content.

### SUMMARY

Embodiments of the present disclosure provide a method, an apparatus, a device, a medium, and a program product for playing content.

According to a first aspect of the present disclosure, a method for playing content is provided. The method includes receiving, at a first client and through a media stream channel, a target media stream from a second client for live streaming, a media frame of the target media stream including metadata. The method further includes determining a message identifier in the metadata in response to the metadata indicating that the media frame is displayed synchronously with a corresponding message. The method further includes determining whether there is a target message with the message identifier in a message queue of a message channel for the live streaming. The method further includes displaying the media frame and the target message synchronously in response to there being the target message in the message queue.

In a second aspect of the present disclosure, a method for playing content is provided. The method includes receiving, at a second client, an operation for synchronously displaying a media frame in an original media stream for live streaming and a target message. The method further includes generating metadata of the media frame based on the operation, the metadata including a message identifier of the target message. The method further includes generating a target media stream by inserting the metadata into the media frame. The method further includes providing the target media stream to a first client through a media stream channel, where the first client synchronously displays the target message and the media frame based on a determination that there is the target message with the message identifier in a message queue of a message channel for the live streaming, the target message being sent to the first client through the message channel for the live streaming.

In a third aspect of the present disclosure, an apparatus for playing content is provided. The apparatus includes a target media stream receiving module configured to receive, at a first client and through a media stream channel, a target media stream from a second client for live streaming, a media frame of the target media stream including metadata; a message identifier determination module configured to determine a message identifier in the metadata in response to the metadata indicating that the media frame is displayed synchronously with a corresponding message; a target message existence determination module configured to determine whether there is a target message with the message identifier in a message queue of a message channel for the live streaming; and a media frame and target message synchronous display module configured to display the media frame and the target message synchronously in response to there being the target message in the message queue.

In a fourth aspect of the present disclosure, an apparatus for playing content is provided. The apparatus includes an operation receiving module for a media frame and a target message, configured to receive, at a second client, an operation for synchronously displaying the media frame in an original media stream for live streaming and the target message; a metadata generation module configured to generate metadata of the media frame based on the operation, the metadata including a message identifier of the target message; a target media stream generation module configured to generate a target media stream by inserting the metadata into the media frame; and a target media stream providing module configured to provide the target media stream to a first client through a media stream channel, where the first client synchronously displays the target message and the media frame based on a determination that there is the target message with the message identifier in a message queue of a message channel for the live streaming, the target message being sent to the first client through the message channel for the live streaming.

In a fifth aspect of the present disclosure, an electronic device is provided. The electronic device includes at least one processor; and a storage for storing at least one program, the at least one program, when executed by the at least one processor, causing the at least one processor to implement the methods according to the first aspect and the second aspect of the present disclosure.

In a sixth aspect of the present disclosure, a computer-readable storage medium is provided. The computer-readable storage medium has a computer program stored thereon which, when executed by a processor, implements the methods according to the first aspect and the second aspect of the present disclosure.

In a seventh aspect of the present disclosure, a computer program product is provided. The computer program product includes a computer program which, when executed by a processor, implements the methods according to the first aspect and the second aspect of the present disclosure.

It should be understood that the content described in this section is not intended to limit key or important features of the embodiments of the present disclosure, nor is it intended to limit the scope of the present disclosure. Other features of the present disclosure will become readily understood through the following description.

### BRIEF DESCRIPTION OF THE DRAWINGS

The above and other objects, features, and advantages of the present disclosure will become more apparent by describing the exemplary embodiments of the present disclosure in more detail in conjunction with the drawings, in which the same reference numerals generally represent the same components in the exemplary embodiments of the present disclosure.

FIG. 1 illustrates a schematic diagram of an example environment in which the device and/or the method of some embodiments of the present disclosure may be implemented;

FIG. 2 illustrates a schematic diagram of an example method 200 for playing content according to some embodiments of the present disclosure;

FIG. 3 illustrates a schematic diagram of an example method 300 for playing content according to some embodiments of the present disclosure;

FIG. 4 illustrates a schematic diagram of an example of generating a target media stream according to some embodiments of the present disclosure;

FIG. 5 illustrates a schematic diagram of an example of synchronously displaying a media frame and a target message according to some embodiments of the present disclosure;

FIG. 6 illustrates a schematic block diagram of an apparatus for playing content according to some embodiments of the present disclosure;

FIG. 7 illustrates a schematic block diagram of an apparatus for playing content according to some embodiments of the present disclosure; and

FIG. 8 illustrates a schematic block diagram of an example device suitable for implementing multiple embodiments of the present disclosure.

In each of the drawings, the same or corresponding reference numerals represent the same or corresponding parts.

### DETAILED DESCRIPTION OF EMBODIMENTS

It may be understood that the data involved in the technical solution (including but not limited to the data itself, acquisition or use of the data) shall comply with requirements of corresponding laws, regulations, and related provisions.

It may be understood that before using the technical solutions disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, when receiving an active request from a user, prompt information is sent to the user to clearly prompt the user that the requested operation will require access to and use of the user's personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other manners that satisfy the relevant laws and regulations may also be applied in the implementations of the present disclosure.

The embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and the embodiments of the present disclosure are only for exemplary purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The terms “first”, “second”, etc. may refer to different or same objects. other definitions, either explicit or implicit, may also be included below.

In a process of playing content, for example, taking a live streaming scenario as an example, information in the live streaming is usually presented in two forms. One is stream picture information of a streamer, that is, content live streamed by the streamer; in addition, a large amount of other information (gift messages, public screen chat messages, administrator messages, streaming pausing by the streamer, e-commerce explanation card messages, etc.) may also be generated in the live streaming. Interaction between the streamer and an audience in the live streaming is completed through the “live streaming message”. These two types of information reach a user device through two different information channels. Due to different transmission modes, there may be a certain time difference between the two types of information, which may lead to a decline in user experience of watching the live streaming. For example, the live streaming is implemented in a form of a live streaming room.

In the above traditional solution, in the live streaming room, stream information of a video picture is pulled by a player from a content delivery network through a specific protocol, while messages of the live streaming room are obtained through a message channel (for example, a Websocket long link) of the live streaming room, and there is a certain time difference between the two. For example, if the end-to-end stream picture has a latency of 5 seconds, while the messages of the live streaming room have a latency of 2 seconds, the time difference between the two is 3 seconds, and the user experience is lost during this time difference. When the content of the live streaming is e-commerce sales, when the streamer is preparing to add a link of a new product and shouts “3, 2, 1, get the link up!”, and an operation of getting the link up is performed on the streamer side, since such operation information is transmitted at an extremely fast speed compared with a video stream, etc., and there is a certain delay in the transmission of the live streaming video stream, audio stream, etc., the audience will see and hear the slogan shouted by the streamer only after the link of the product has been put on the shelf by the merchant, which leads to an experience of audio-visual asynchronization for the user when watching the live streaming, reduces a willingness of the audience to continue watching the live streaming, and greatly reduces the experience of the audience watching the live streaming.

To solve at least the above and other potential problems, the embodiments of the present disclosure provide a method for playing content. In this method, at a first client, a target media stream from a second client for live streaming is first received through a media stream channel, where a media frame of the target media stream includes metadata. Then, when it is determined that the metadata indicates that the media frame is displayed synchronously with a corresponding message, a message identifier in the metadata is determined. Next, the first client determines whether there is a target message with the message identifier in a message queue of a message channel for the live streaming. Finally, if there is the target message in the message queue, the media frame and the target message are displayed synchronously. Through this method, the target message may be displayed synchronously with the media frame, which avoids the target message being displayed on the first client before the media frame reaches the first client, and greatly improves the experience of a user watching the live streaming.

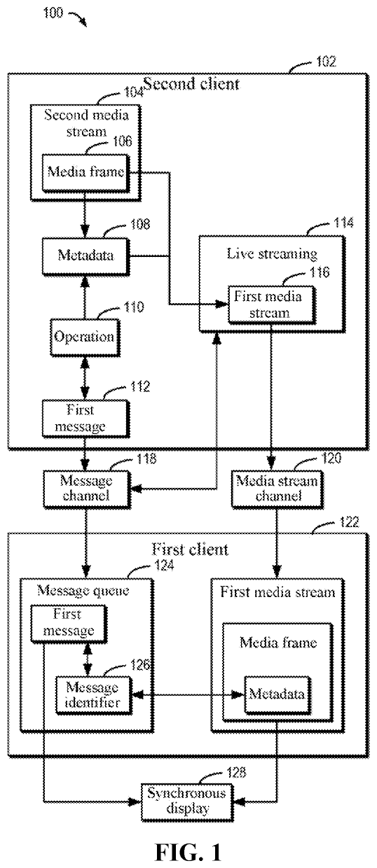

The embodiments of the present disclosure will be further described in detail below in conjunction with the drawings. FIG. 1 illustrates an example environment in which the device and/or the method of the embodiments of the present disclosure may be implemented. In environment 100, taking a live streaming scenario as an example, client 122 is an audience side, which may also be referred to as a first client for ease of description, and client 102 is a streamer side, which may also be referred to as a second client for ease of description. Original media stream 104 is a data stream displayed on the streamer side, and original media stream 104 may be a video stream and/or an audio stream.

It may be understood that the present application is only described in conjunction with related embodiments, and the related embodiments are not intended to limit the protection scope of the present application. Any technical solution in other applications that falls within the protection scope of the present application shall be protected.

In environment 100 of FIG. 1, at client 102, since it is a live streaming side, an original media stream may be acquired for display during live streaming. For example, if a streamer is streaming live, the original media stream may be a video of the streamer acquired by a camera device in client 102. For live streaming 114, the streamer may also exchange messages with the audience side. For example, interaction between the streamer and an audience in a live streaming room of live streaming 114, such as the streamer and the audience chatting in a public screen, may be completed through a “live streaming message”. In addition, it may also be sending a gift message, an administrator message, pausing the live streaming by the streamer, an e-commerce explanation card message, etc. For presentation of some messages, the messages and a media frame in a corresponding media stream need to be displayed simultaneously on a client on the audience side. At this time, client 102 may receive an operation 110 for synchronously displaying a media frame 106 in original media stream 104 and a target message 112 on the audience side. For example, in a scenario of getting a product link up, the streamer says “get the link up” and clicks a “get the link up” button in the live streaming, and the click operation may trigger synchronous display of media frame 106 and target message 112 on the audience side. After the click operation, a request for the operation may be sent to a server, and then the server generates target message 112, returns an identifier of the target message to client 102, and sends target message 112 to client 122.

In some embodiments, media frame 106 may be one of multiple media frames in original media stream 104. Target message 112 may be a specific message for a current live streaming service scenario, for example, if the current live streaming scenario is e-commerce explanation, target message 112 may be information about a product link being put on the shelf.

Next, after operation 110 for target message 112 is determined, metadata 108 of media frame 106 synchronously displayed with target message 112 may be generated, where metadata 108 includes a message identifier 126 of target message 112.

Metadata 108 is determined according to message identifier 126 of target message 112. In some embodiments, metadata 108 is further determined according to a scene identifier and a time stamp of a scene corresponding to media frame 106. Additionally, the scene identifier and the time stamp are generated by client 102 after receiving operation 110. Subsequently, client 102 inserts generated metadata 108 into media frame 106 to generate target media stream 116.

In some embodiments, metadata 108 is in a form of Supplemental Enhancement Information (SEI). Additionally, media frame 106 is a latest media frame in terms of time among multiple media frames in original media stream 104, and temporally corresponds to the target message.

Finally, target media stream 116 is provided to client 122 through media stream channel 120. Then, client 122 may acquire the metadata in the media frame in the target media stream. Then, client 122 further determines whether the media frame has a synchronous message according to whether the metadata indicates that the media frame is displayed synchronously with a corresponding message. In one example, a data format of the metadata may be used to determine whether the metadata indicates that the media frame is displayed synchronously with the corresponding message. If the metadata is not in a predetermined format, it indicates that the media frame does not have a message displayed synchronously. At this time, the media frame is displayed directly without further processing. If the metadata is in the predetermined format, it may be determined that the media frame has a message that may be displayed synchronously. In another example, an identifier flag may be set for the metadata, and whether the metadata indicates that the media frame is displayed synchronously with the corresponding message is determined based on the identifier flag. For example, if the identifier flag is set to 0, it indicates that the metadata does not indicate that the media frame is displayed synchronously with the corresponding message; if the identifier flag is set to 1, it indicates that the metadata indicates that the media frame is displayed synchronously with the corresponding message. The above examples are only used to describe the present disclosure, rather than specifically limiting the present disclosure.

Then, client 122 checks that there is target message 112 with message identifier 126 in message queue 124 of message channel 118 for live streaming 114 to synchronously display target message 112 and media frame 106. If target message 112 has not arrived in the message queue, it indicates that stream data arrives earlier than the message, and the metadata is stored in a metadata queue for the media stream to wait for the arrival of target message 112 for display, while at this time the media frame needs to be displayed directly. If there is target message 112 in the message queue, it indicates that the target message arrives fast. At this time, media frame 106 and target message 112 are displayed synchronously at 128. Target message 112 is sent to client 122 through message channel 118 for live streaming 114.

Message channel 118 and media stream channel 120 are used to transmit different types of data. In some embodiments, a message transmission rate in message channel 118 is faster than a media stream transmission rate in media stream channel 120. Additionally, message queue 124 stores multiple messages from message channel 118, and the multiple messages are all messages generated by client 102 that need to be displayed synchronously with a video frame.

Through this method, the metadata corresponding to the media frame in the original media stream is generated based on the operation for the target message, and then the metadata is inserted into the media frame. Then, the processed media frame and the target message are transmitted to the first client through the media stream channel and the message channel, respectively, via the second client, so that the message identifier in the metadata of the media frame and a message identifier in the message queue are matched, the target message may be displayed synchronously with the media frame, which avoids the target message being displayed on the first client before the media frame reaches the first client, and greatly improves the experience of a user watching the live streaming.

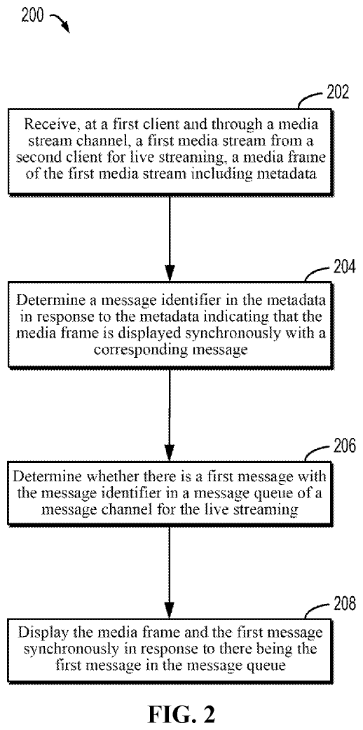

A schematic diagram of an example environment in which the devices and/or methods of some embodiments of the present disclosure may be implemented is described above with reference to FIG. 1, and a schematic diagram of an example method 200 for playing content according to some embodiments of the present disclosure is described below with reference to FIG. 2. The example method may be performed by client 122 in FIG. 1 or any suitable computing device.

As shown in FIG. 2, in example method 200, at block 202, a target media stream from a second client for live streaming is received at a first client through a media stream channel, a media frame of the target media stream including metadata. For example, client 122 receives, through the media stream channel, target media stream 116 from client 102 for live streaming. For example, client 122 acquires target media stream 116 in client 102 through a content delivery network, at this time, client 122 pulls target media stream 116 from the content delivery network. In some embodiments, the target media stream includes multiple media frames, and the media frame in the multiple media frames may include the metadata, which may have different formats.

Next, at block 204, a message identifier in the metadata is determined in response to the metadata indicating that the media frame is to be displayed synchronously with a corresponding message. For example, after acquiring the media frame, client 122 needs to parse its metadata. If the metadata is in a predetermined format, it indicates that the data frame has a message presented therewith. The metadata in the predetermined format includes at least a message identifier of the message presented therewith. Therefore, after determining that the metadata is in the predetermined format, client 122 may acquire message identifier 126 in the metadata.

In some embodiments, a data type of the metadata may be a supplemental enhancement information type, and the metadata may have different data formats, while the predetermined format indicates that the media frame has a corresponding message displayed synchronously. In one example, the predetermined format is that the metadata includes three parts of information, the first part of information is an identifier of the message to be displayed synchronously, the second part of information is an identifier of a scene in which the live streaming is performed, for example, an identifier of a scene in which the live streaming room is located, and the third part of information is a time stamp of message creation. Additionally, the predetermined format is MessageSEIMeta. Only after it is determined that the metadata is in a predetermined data format, the message identifier in the metadata is further determined. For example, the MessageSEIMeta format is as in the following example:

{
“message_id”: xxxx // id of the message
“scene”: “xxx”, // scene identifier
“timestamp”: xxx// time stamp of information creation
}

In some embodiments, when it is determined that the metadata does not indicate that the media frame is to be displayed synchronously with the corresponding message, it may be determined that the media frame corresponding to the metadata may be displayed directly, and content of the media frame is further displayed directly.

Then, at block 206, it is determined whether there is a target message with the message identifier in a message queue of a message channel for the live streaming. After obtaining the video frame to be displayed synchronously, it is further necessary to determine whether the corresponding target message has arrived at client 122 based on the message identifier in the metadata.

Therefore, after determining that the metadata indicates that the media frame is to be displayed synchronously with the corresponding message and determining the message identifier in the metadata, client 122 further determines whether there is the target message with the message identifier in the message queue in the message channel for the live streaming. The message queue stores multiple reference messages from the live streaming room for live streaming, each reference message has a corresponding message identifier, and the message identifier is consistent with the message identifier in the metadata of the corresponding media frame.

In some embodiments, the message identifier in the metadata is matched with a reference identifier of the reference message in the message queue. If it is determined that the message identifier in the metadata matches the reference identifier of the reference message, the reference message is determined as the target message. At this time, the media frame corresponding to the metadata is successfully matched with the target message.

Finally, at block 208, the media frame and the target message are displayed synchronously in response to there being the target message in the message queue. When it is determined that the message queue includes the target message, it indicates that the target message has arrived at the first client earlier than the video frame.

After it is determined that there is the target message in the message queue, it may indicate that the message identifier of the target message in the message queue is successfully matched with the message identifier in the metadata. At this time, the media frame corresponding to the metadata and the target message are synchronously displayed on the audience side. For example, the target message may include information available for presenting a target item, so as to present the target item, such as presenting an item on the shelf in the live streaming, and the media frame or the media stream may be used to prompt the user to present the target item, so that the user may view the target item presented by the target message. In this way, it may be ensured that when the target message arrives first, it waits for the arrival of the corresponding video frame for synchronous display.

In some embodiments, when there is no target message in the message queue, the metadata is stored in a metadata queue, and then content of the media frame corresponding to the metadata is directly displayed.

In some embodiments, the above target message is a first message. The first client may further receive a second message for the live streaming from the second client through the message channel. A process of receiving the second message is described below, and a process of receiving the first message is similar to the process of receiving the second message described below, and thus will not be described in detail.

When receiving the second message, client 122 determines whether the second message is a message of a predetermined type. When the second message is the message of the predetermined type, it indicates that the message has a corresponding video frame to be displayed synchronously. For example, when the second message is the message of the predetermined type LiveSEIMessage, it indicates that the second message has a corresponding video frame to be displayed synchronously. Then, client 122 further determines an identifier for the second message, and then processes the second message based on the identifier of the second message.

For example, after determining that the second message is the message of the predetermined type, it is determined whether the metadata queue includes an identifier of the second message. The metadata queue is a queue used to store the metadata that is received through the media stream channel and that has the predetermined format. When it is determined that the metadata in the metadata queue includes the identifier of the second message, it indicates that the video frame arrives earlier than the message, and at this time, content of the second message is directly displayed. Additionally, after displaying the content of the second message, the metadata corresponding to the identifier of the second message is removed from the metadata queue.

In some embodiments, the metadata in the metadata queue does not include the identifier of the second message, indicating that the message arrives at client 122 earlier than the media frame. At this time, a waiting time for the second message is further determined, and the waiting time is an average delay time of the media frame in the target media stream (for example, 500 milliseconds). Then, the second message is put into the message queue.

When the waiting time for the second message in the message queue expires and the second message has not been processed, that is after the average delay time is exceeded. At this time, the second message is removed from the message queue, and the content of the second message is displayed.

Through this method, the media frame in the original media stream is processed, the metadata corresponding to the operation for the target message is determined, and then the metadata is inserted into the media frame. Then, the processed media frame and the target message are transmitted to the first client through the media stream channel and the message channel, respectively, via the second client, and the message identifier in the metadata of the media frame and the message identifier in the message queue are matched, or the message identifier and a message identifier in the metadata in the metadata queue are matched, so that the target message may be displayed synchronously with the media frame, which avoids the target message being displayed on the first client before the media frame reaches the first client, and greatly improves the experience of a user watching the live streaming.

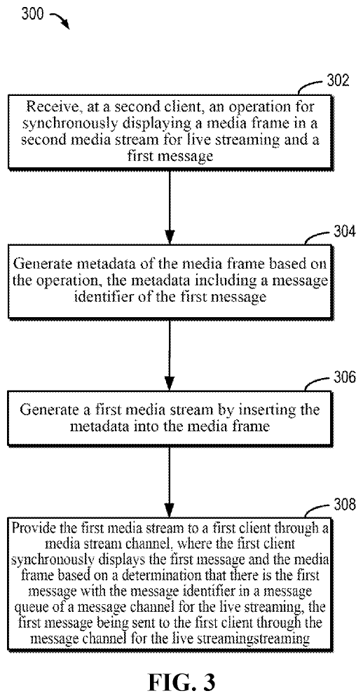

The schematic diagram of the example method 200 for playing content according to some embodiments of the present disclosure is described above with reference to FIG. 2, and a schematic diagram of an example method 300 for playing content according to some embodiments of the present disclosure is described below with reference to FIG. 3. The example method may be performed by client 102 in FIG. 1 or any suitable device.

As shown in FIG. 3, in example method 300, at block 302, an operation for synchronously displaying a media frame in an original media stream for live streaming and a target message is received at a second client. Client 102 performs live streaming, for example, in a live streaming room for live streaming, which is used to provide a media stream and messages to client 122 for a user at client 122 to watch or interact with. In the live streaming of client 102, there may be some operations that require a video frame in the media stream and a corresponding target message to be synchronously displayed on client 122.

In some embodiments, the original media stream is a media stream displayed at client 102. The original media stream includes multiple media frames. In one example, the original media stream may include a video stream, for example, a video stream captured by a camera of client 102. In another example, the original media stream may further include a video stream and an audio stream.

In some embodiments, the target message may be a message for a business scenario that is currently live streamed, and it is a message that needs to be displayed synchronously with the media frame in the displayed media stream. For example, if the business scenario currently being live streamed is a talent show and the streamer is singing, the target message may be a prompt message for the streamer to switch songs provided to a user in the live streaming room; or it may be item information presented when an item is linked up.

In some embodiments, the operation may be a click operation or a long press operation for a target control or information in client 102. It may also be any other operation that may achieve control over the target message.

Next, at block 304, metadata of the media frame is generated based on the operation, the metadata including a message identifier of the target message. For example, client 102 may generate the metadata including message identifier of target message 112. The media frame is a media frame in the media stream that temporally corresponds to the target message when the operation is performed. For example, in the operation of getting a link up, the media frame may be a media frame corresponding to a time when the target message is generated by clicking a button to get the link up, e.g., a media frame that includes the streamer saying “get the link up”.

In some embodiments, generation of the metadata may be achieved by acquiring an identifier of the target message displayed synchronously with the media frame. In some other embodiments, a scene identifier of a scene corresponding to the media frame and a time stamp corresponding to the media frame may be further acquired, and then the metadata is generated according to the scene identifier, the time stamp in combination with the identifier of the target message.

Then, at block 306, a target media stream is generated by inserting the metadata into the media frame. In order to display the media frame and the target message synchronously, it is necessary to insert the metadata into the media frame to generate the media frame including the metadata. Then, the media frame, in combination with other media frames in the original video stream, constitutes the target media stream.

Finally, at block 308, the target media stream is provided to a first client through a media stream channel, where the first client synchronously displays the target message and the media frame based on a determination that there is the target message with the message identifier in a message queue of a message channel for the live streaming, the target message being sent to the first client through the message channel for the live streaming.

In some embodiments, the media stream channel and the message channel are implemented by different servers, for example, the media stream channel is implemented by a content delivery network, while the message channel is implemented by a server corresponding to a live streaming application. Additionally, when the server related to the live streaming receives the operation for the media frame and the target message, the server generates the target message and an identifier of the target message. Then, the server sends the target message to the first client, and sends the identifier of the target message to the second client for generating the metadata.

Through this method, the media frame in the original media stream is processed, the metadata corresponding to the operation for the target message is determined, and then the metadata is inserted into the media frame. Then, the processed media frame and the target message are transmitted from the second client to the first client through the media stream channel and the message channel, respectively, so that the target message may be displayed synchronously with the media frame, which avoids the target message being displayed on the first client before the media frame reaches the first client, and greatly improves the experience of a user watching the live streaming.

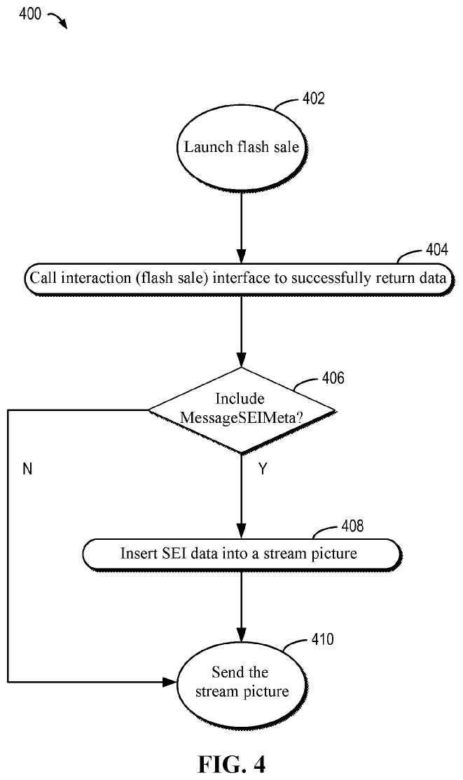

The schematic diagram of the example method 300 for playing content according to some embodiments of the present disclosure is described above with reference to FIG. 3, and a schematic diagram of an example of generating a target media stream according to some embodiments of the present disclosure is described below with reference to FIG. 4.

As shown in FIG. 4, in example 400, the target message is an interactive message. At block 402, the streamer launches a flash sale operation. At block 404, a server calls an interaction (flash sale) interface to successfully return data. In this process, the server returns a message identifier for the target message to the streamer side.

At block 406, client 102 determines whether MessageSEIMeta metadata is included in a stream picture, for example, according to a type of the flash sale operation or a type of a returned message. If it is determined that the MessageSEIMeta metadata is not required to be included, the stream picture is directly sent at block 410.

If the MessageSEIMeta metadata is required to be included, at block 408, SEI data (MessageSEIMeta metadata) is inserted into the stream picture. In one example, the SEI data is inserted into the media frame corresponding to the stream picture. Additionally, the media frame is a media frame temporally corresponding to the target message among multiple media frames in the stream picture.

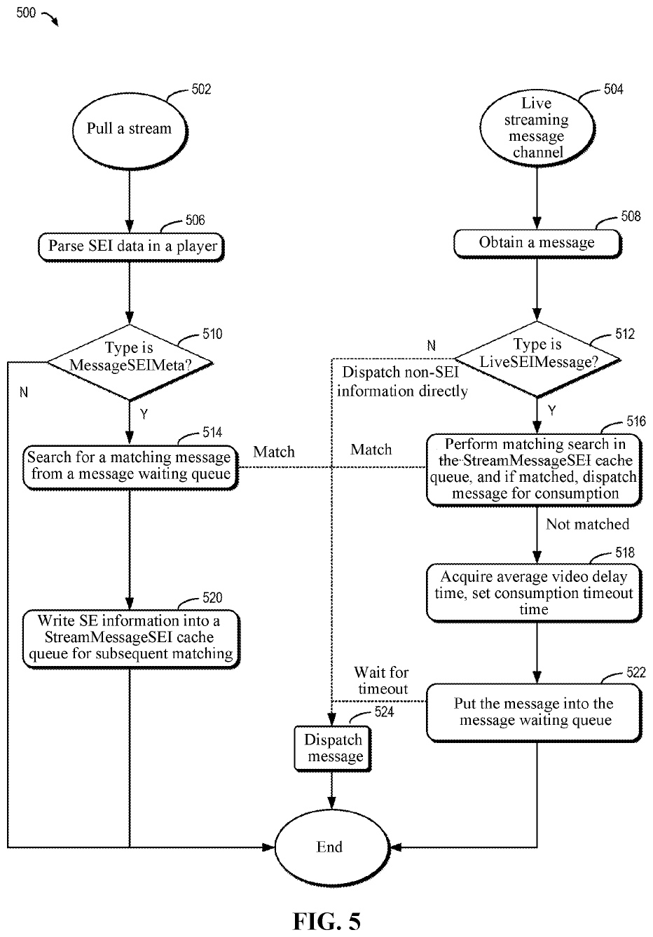

The schematic diagram of the example of generating the target media stream according to some embodiments of the present disclosure is described above with reference to FIG. 4, and a schematic diagram of an example of synchronously displaying a media frame and a target message according to some embodiments of the present disclosure is described below with reference to FIG. 5.

As shown in FIG. 5, in example 500, in combination with previous example 400, it is an operation performed by a client on an audience side. Client 122 pulls a stream from a media stream channel at block 502, and obtains a message through a live streaming message channel 504 at block 508, for example, the obtained message may be the first message or the second message as described above.

After pulling the stream, client 122 parses SEI data in a player at block 506, and parses a data format of the metadata to determine whether its type is MessageSEIMeta at block 510. If the data format of the metadata is not MessageSEIMeta, the media frame in the target media stream is directly displayed.

If it is determined that the data format of the metadata is MessageSEIMeta, at block 514, a matching message is searched for from a message waiting queue, and whether there is a reference message with the same message identifier is searched for from the message waiting queue according to the message identifier in the metadata. If the matching reference message is found from the message waiting queue, at block 524, the message is directly dispatched, and the media frame corresponding to the metadata and the target message are synchronously displayed.

If the matching reference message is not found from the message waiting queue, the corresponding metadata is stored, and at block 520, SEI information is written into a StreamMessageSEI cache queue for subsequent matching.

After obtaining the message, client 122 further determines whether a type of the message is LiveSEIMessage at block 512, the LiveSEIMessage being used to indicate that the message is a message of the predetermined type. Usually, the message includes a field for LiveSEIMessage, and if it is this type, the field is identified as 1, and if not, it may be identified as Null. If it is determined that the type of the message is not LiveSEIMessage, indicating that it is non-SEI information, the message is directly dispatched.

If it is determined that the message is the LiveSEIMessage type, that is, a message type of the message is determined to be the predetermined type, at block 516, a matching search is directly performed from the StreamMessageSEI cache queue (metadata queue) to find out whether there is the metadata including an identifier of the message. If the metadata including the identifier of the second message is matched, the message is directly dispatched at block 524.

If the metadata including the identifier of the message is not matched, at block 518, an average video delay time is acquired, and a consumption timeout time is set. For example, if the acquired average video delay time is 500 milliseconds, the consumption timeout time (the waiting time for the message) may be set to the average video delay time. Additionally, the waiting time for the message may also be set to 1 second, which is not limited in the present disclosure.

After setting the waiting time for the second message, at block 522, the message (the second message) is put into the message waiting queue, and after the waiting time of the second message in the waiting queue exceeds the preset waiting time, it is determined that the waiting for the second message times out, at this time, the second message is dispatched and displayed on the audience side.

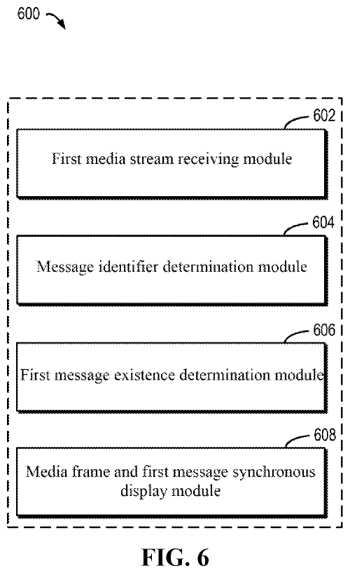

As shown in FIG. 6, apparatus 600 includes a target media stream receiving module 602 configured to receive, at a first client and through a media stream channel, a target media stream from a second client for live streaming, a media frame of the target media stream including metadata; a message identifier determination module 604 configured to determine a message identifier in the metadata in response to the metadata indicating that the media frame is to be displayed synchronously with a corresponding message; a target message existence determination module 606 configured to determine whether there is a target message with the message identifier in a message queue of a message channel for the live streaming; and a media frame and target message synchronous display module 608 configured to display the media frame and the target message synchronously in response to there being the target message in the message queue.

In some embodiments, apparatus 600 further includes: a media frame display determination module configured to determine that the media frame may be displayed directly in response to the metadata not indicating that the media frame is displayed synchronously with the corresponding message; and a content display module for the media frame configured to display content of the media frame.

In some embodiments, target message existence determination module 606 includes: a message identifier and reference identifier matching module configured to match the message identifier with a reference identifier of a reference message in the message queue; and a target message determination module configured to determine the reference message as the target message in response to the message identifier matching the reference identifier.

In some embodiments, apparatus 600 further includes: a metadata storage module configured to store the metadata in a metadata queue in response to there being no target message in the message queue; and a content display module for the media frame configured to display content of the media frame.

In some embodiments, the target message is a first message, and apparatus 600 further includes: a second message receiving module configured to receive a second message for the live streaming through the message channel; a second message predetermined type determination module configured to determine whether the second message is a message of a predetermined type, the predetermined type indicating that the message is displayed synchronously with a corresponding media frame; and a second message processing module configured to process the second message based on an identifier of the second message in response to the second message being the message of the predetermined type.

In some embodiments, the second message processing module includes: an identifier determining module configured to determine whether metadata in the metadata queue includes the identifier of the second message; a content display module for the second message configured to display content of the second message in response to the metadata in the metadata queue including the identifier of the second message; and a metadata removing module configured to remove the metadata from the metadata queue.

In some embodiments, the second message processing module further includes: a waiting time determination module configured to determine a waiting time for the second message in response to the metadata in the metadata queue not including the identifier of the second message, the waiting time being an average delay time of the media frame in the target media stream; and a message putting module configured to put the second message into the message queue.

In some embodiments, the second message processing module further includes: a second message removing module configured to remove the second message from the message queue in response to the waiting time for the second message in the message queue expiring; and a content display module for the second message configured to display the content of the second message.

In some embodiments, the target message is used to present a target item, and the media frame is used to prompt to present the target item.

As shown in FIG. 7, apparatus 700 includes an operation receiving module 702 for a media frame and a target message, configured to receive, at a second client, an operation for synchronously displaying the media frame in an original media stream for live streaming and the target message; a metadata generation module 704 configured to generate metadata of the media frame based on the operation, the metadata including a message identifier of the target message; a target media stream generation module 706 configured to generate a target media stream by inserting the metadata into the media frame; and a target media stream providing module 708 configured to provide the target media stream to a first client through a media stream channel, where the first client synchronously displays the target message and the media frame based on a determination that there is the target message with the message identifier in a message queue of a message channel for the live streaming, the target message being sent to the first client through the message channel for the live streaming.

In some embodiments, metadata generation module 704 includes: an identifier acquiring module for the target message configured to acquire an identifier of the target message to be displayed synchronously with the media frame; a scene identifier and time stamp determination module configured to determine a scene identifier of a scene corresponding to the media frame and a time stamp corresponding to the media frame; and a metadata generation module configured to generate the metadata based on the identifier of the target message, the scene identifier and the time stamp.

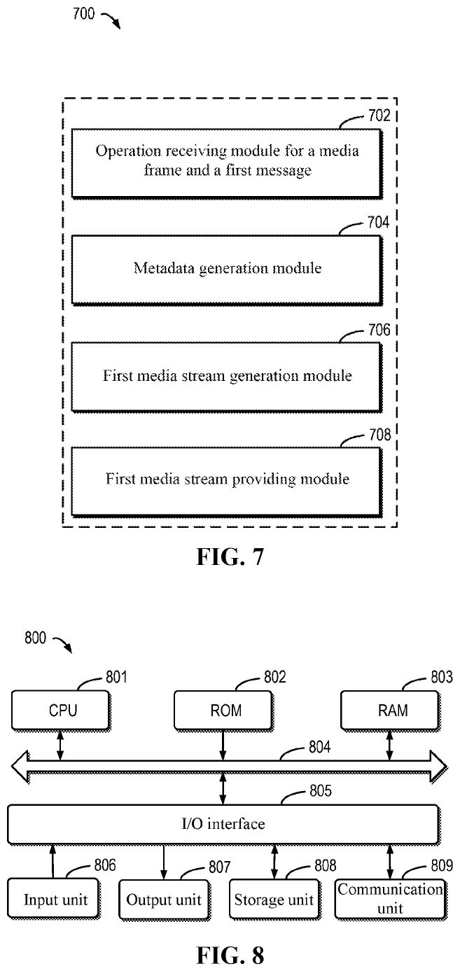

FIG. 8 shows a schematic block diagram of an example device 800 that may be used to implement the embodiments of the present disclosure. Second client 102 and first client 122 in FIG. 1 may be implemented using device 800. As shown in the figure, device 800 includes a central processing unit (CPU) 801 that may perform various appropriate actions and processes based on computer program instructions stored in a read-only memory (ROM) 802 or computer program instructions loaded from a storage unit 808 into a random access memory (RAM) 803. In RAM 803, various programs and data required for operations of device 800 may also be stored. CPU 801, ROM 802, and RAM 803 are connected to each other through a bus 804. An input/output (I/O) interface 805 is also connected to bus 804.

Multiple components in device 800 are connected to I/O interface 805, and the components include: an input unit 806, such as a keyboard, a mouse, etc.; an output unit 807, such as various types of displays, speakers, etc.; the storage unit 808, such as a magnetic disk, an optical disc, etc.; and a communication unit 809, such as a network card, a modem, a wireless communication transceiver, etc. Communication unit 809 allows device 800 to exchange information/data with other devices through a computer network such as Internet and/or various telecommunication networks.

The various processes and treatments described above, such as methods 200, 300 and examples 400-500, may be performed by processing unit 801. For example, in some embodiments, methods 200, 300 and examples 400-500 may be implemented as computer software programs tangibly contained in a machine-readable medium, such as storage unit 808. In some embodiments, a portion or an entirety of a computer program may be loaded and/or installed into device 800 via ROM 802 and/or communication unit 809. When the computer program is loaded into RAM 803 and executed by CPU 801, one or more actions of the above-described example methods 200, 300 and examples 400-500 may be performed.

The present disclosure may be a method, an apparatus, a system, and/or a computer program product. The computer program product may include a computer-readable storage medium having computer-readable program instructions stored thereon for performing various aspects of the present disclosure.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanically encoded device, such as a punched card or a raised structure in a groove having instructions stored thereon, and any suitable combination thereof. The computer-readable storage medium used herein is not interpreted as an instantaneous signal per se, such as a radio wave or other freely propagating electromagnetic wave, an electromagnetic wave propagating through a waveguide or other transmission medium (for example, a light pulse through an optical fiber cable), or an electrical signal transmitted through a wire.

The computer-readable program instructions described herein may be downloaded from the computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network, and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages, such as Smalltalk, C++, etc., and conventional procedural programming languages, such as “C” language or similar programming languages. The computer-readable program instructions may be executed entirely on a user computer, partly on the user computer, as a stand-alone software package, partly on the user computer and partly on a remote computer, or entirely on the remote computer or a server. In the case involving the remote computer, the remote computer may be connected to the user computer through any kind of network, including a local area network (LAN) or a wide area network (WAN), or it may be connected to an external computer (for example, connected via Internet with the aid of an Internet service provider). In some embodiments, by customizing an electronic circuit, such as a programmable logic circuit, a field programmable gate array (FPGA) or a programmable logic array (PLA), with state information of the computer-readable program instructions, the electronic circuit may execute the computer-readable program instructions, thereby implementing various aspects of the present disclosure.

Various aspects of the present disclosure are described herein with reference to flowcharts and/or block diagrams of the method, the apparatus (system), and the computer program product according to the embodiments of the present disclosure. It should be understood that each block of the flowcharts and/or block diagrams, and combinations of the blocks in the flowcharts and/or block diagrams may be implemented by the computer-readable program instructions.

These computer-readable program instructions may be provided to a processing unit of a general-purpose computer, a dedicated computer, or other programmable data processing apparatus to produce a machine, such that these instructions, when executed by the processing unit of the computer or other programmable data processing apparatus, produce an apparatus for implementing a function/action specified in one or more blocks of the flowcharts and/or block diagrams. These computer-readable program instructions may also be stored in the computer-readable storage medium, and these instructions cause the computer, the programmable data processing apparatus, and/or other devices to work in a specific manner, so that the computer-readable medium storing the instructions includes a manufactured product, which includes instructions for implementing various aspects of the function/action specified in one or more blocks of the flowcharts and/or block diagrams.

The computer-readable program instructions may also be loaded onto the computer, other programmable data processing apparatus, or other devices, so that a series of operation steps are performed on the computer, other programmable data processing apparatus, or other devices to produce a computer-implemented process, which makes the instructions executed on the computer, other programmable data processing apparatus, or other devices implement the function/action specified in one or more blocks of the flowcharts and/or block diagrams.

The flowcharts and block diagrams in the figures show the possibly implemented architectures, functions, and operations of the system, the method, and the computer program product according to multiple embodiments of the present disclosure. In this regard, each block in the flowchart or block diagram may represent a module, a program segment, or a portion of instruction, and the module, the program segment, or the portion of instruction contains one or more executable instructions for implementing the specified logical function. In some alternative implementations, the functions marked in the blocks may also occur in an order different from that marked in the figures. For example, two consecutive blocks may actually be performed substantially in parallel, or they may sometimes be performed in a reverse order, depending on the functions involved. It should also be noted that each block in the block diagrams and/or flowcharts, and the combinations of the blocks in the block diagrams and/or flowcharts may be implemented by a dedicated hardware-based system that executes specified functions or actions, or may be implemented by a combination of dedicated hardware and computer instructions.

The embodiments of the present disclosure have been described above, and the above description is exemplary, non-exhaustive, and not limited to the disclosed embodiments. Without departing from the scope and spirit of the described embodiments, many modifications and changes will be apparent to those of ordinary skill in the art. The terminology used herein is chosen to best explain the principles of the embodiments, the actual application or the technical improvement to the technology in the market, or to enable other those of ordinary skill in the art to understand the embodiments disclosed herein.

I/We claim:

1. A method for playing content, comprising:
receiving, at a first client and over a media stream channel, a first media stream from a second client for live streaming, a media frame of the first media stream comprising metadata;
determining, in response to the metadata indicating that the media frame is displayed synchronously with a corresponding message, a message identifier in the metadata;
determining whether a first message with the message identifier is present in a message queue of a message channel for the live streaming; and
displaying, in response to the first message being present in the message queue, the media frame and the first message synchronously.

2. The method of claim 1, further comprising:
determining, in response to the metadata not indicating that the media frame is displayed synchronously with the corresponding message, that the media frame is to be displayed directly; and
displaying content of the media frame.

3. The method of claim 1, wherein determining whether the first message with the message identifier is present in the message queue of the message channel for the live streaming comprises:
matching the message identifier with a reference identifier of a reference message in the message queue; and
determining, in response to the message identifier matching the reference identifier, the reference message as the first message.

4. The method of claim 1, further comprising:
storing, in response to no first message being present in the message queue, the metadata in a metadata queue; and
displaying content of the media frame.

5. The method of claim 4, further comprising:
receiving a second message for the live streaming over the message channel;
determining whether the second message is a message of a predetermined type, the predetermined type indicating that the message is displayed synchronously with a corresponding media frame; and
processing, in response to the second message being the message of the predetermined type, the second message based on an identifier of the second message.

6. The method of claim 5, wherein processing the second message based on the identifier of the second message comprises:
determining whether the metadata in the metadata queue comprises the identifier of the second message;
displaying, in response to the metadata in the metadata queue comprising the identifier of the second message, content of the second message; and
removing the metadata from the metadata queue.

7. The method of claim 6, wherein processing the second message based on the identifier of the second message further comprises:
determining, in response to the metadata in the metadata queue not comprising the identifier of the second message, a waiting time for the second message, the waiting time being an average delay time of the media frame in the first media stream; and
putting the second message into the message queue.

8. The method of claim 7, wherein processing the second message based on the identifier of the second message further comprises:
removing, in response to the waiting time of the second message in the message queue having expired, the second message from the message queue; and
displaying the content of the second message.

9. The method of claim 1, wherein the first message is configured to present an item, and the media frame is configured to prompt to present the item.

10. A method for playing content, comprising:
receiving, at a second client, an operation for synchronously displaying a media frame in a second media stream for live streaming and a first message;
generating metadata of the media frame based on the operation, the metadata comprising a message identifier of the first message;
generating a first media stream by inserting the metadata into the media frame; and
providing the first media stream to a first client over a media stream channel, wherein the first client synchronously displays the first message and the media frame based on a determination that the first message with the message identifier is present in a message queue of a message channel for the live streaming, the first message is sent to the first client over the message channel for the live streaming.

11. The method of claim 10, wherein generating the metadata of the media frame comprises:
acquiring an identifier of the first message to be displayed synchronously with the media frame;
determining a scene identifier of a scene corresponding to the media frame and a time stamp corresponding to the media frame; and
generating the metadata based on the identifier of the first message, the scene identifier and the time stamp.

12. An electronic device, comprising:
at least one processor; and
a storage for storing at least one program, wherein the at least one program, when executed by the at least one processor, causes the at least one processor to:
receive, at a first client and over a media stream channel, a first media stream from a second client for live streaming, a media frame of the first media stream comprising metadata;
determine, in response to the metadata indicating that the media frame is displayed synchronously with a corresponding message, a message identifier in the metadata;
determine whether a first message with the message identifier is present in a message queue of a message channel for the live streaming; and
display, in response to the first message being present in the message queue, the media frame and the first message synchronously.

13. The electronic device according to claim 12, wherein the at least one program further causes the at least one processor to:
determine, in response to the metadata not indicating that the media frame is displayed synchronously with the corresponding message, that the media frame is to be displayed directly; and
display content of the media frame.

14. The electronic device according to claim 12, wherein the at least one program causing the at least one processor to determine whether the first message with the message identifier is present in the message queue of the message channel for the live streaming further causes the at least one processor to:
match the message identifier with a reference identifier of a reference message in the message queue; and
determine, in response to the message identifier matching the reference identifier, the reference message as the first message.

15. The electronic device according to claim 12, wherein the at least one program further causes the at least one processor to:
store, in response to no first message being present in the message queue, the metadata in a metadata queue; and
display content of the media frame.

16. The electronic device according to claim 15, wherein the first message is a first message, and the at least one program further causes the at least one processor to:
receive a second message for the live streaming over the message channel;
determine whether the second message is a message of a predetermined type, the predetermined type indicating that the message is displayed synchronously with a corresponding media frame; and
process, in response to the second message being the message of the predetermined type, the second message based on an identifier of the second message.

17. The electronic device according to claim 16, wherein the at least one program causing the at least one processor to process the second message based on the identifier of the second message further causes the at least one processor to:
determine whether the metadata in the metadata queue comprises the identifier of the second message;
display, in response to the metadata in the metadata queue comprising the identifier of the second message, content of the second message; and
remove the metadata from the metadata queue.

18. The electronic device according to claim 17, wherein the at least one program causing the at least one processor to process the second message based on the identifier of the second message further causes the at least one processor to:
determine, in response to the metadata in the metadata queue not comprising the identifier of the second message, a waiting time for the second message, the waiting time being an average delay time of the media frame in the first media stream; and
put the second message into the message queue.

19. The electronic device according to claim 18, wherein the at least one program causing the at least one processor to process the second message based on the identifier of the second message further causes the at least one processor to:
remove, in response to the waiting time of the second message in the message queue having expired, the second message from the message queue; and
display the content of the second message.

20. The electronic device according to claim 12, wherein the first message is configured to present an item, and the media frame is configured to prompt to present the item.
